(19) United States
(12) Patent Application Publication
(10) Pub. No.: US 2013/0294014 A1
(43) Pub. Date: Nov. 7, 2013

(54) RELAY WITH INTEGRATED POWER SENSOR

(71) Applicant: Travis Irons, Reno, NV (US)

(72) Inventor: Travis Irons, Reno, NV (US)

(73) Assignee: SERVER TECHNOLOGY, INC., Reno, NV (US)

(21) Appl. No.: 13/556,748

(22) Filed: Jul. 24, 2012

Related U.S. Application Data
(60) Provisional application No. 61/641,785, filed on May 2, 2012.

(51) Int. Cl. H02B 7/00; H01H 9/00

(52) U.S. Cl. CPC H02B 7/00; H01H 9/00
USPC 361/626; 335/2

(57) ABSTRACT

Methods, systems, and devices for power parameter sensing using power sensing components integrated into a relay are described. A power distribution unit may be provided with switched outputs that may provide or interrupt power provided to the output through a plurality of relays. The plurality of relays may include an integrated power sensor configured to sense one or more power parameters associated with power delivered to a respective power output. A power-related information reporting system may be coupled with the relays and configured to report power-related information derived from the power sensor to a remote system.

### CROSS-REFERENCE TO RELATED APPLICATIONS

This application claims priority to U.S. Provisional Patent Application Ser. No. 61/641,785 entitled “Relay With Integrated Power Sensor,” and filed on May 2, 2012, the entire disclosure of which is incorporated herein by reference.

### FIELD

The present disclosure is directed to current detection in electronic components and, more specifically, to a relay having an integrated power sensor.

### BACKGROUND

A conventional Power Distribution Unit (PDU) is an assembly of electrical outlets (also called receptacles) that receive electrical power from a source and distribute the electrical power to one or more separate electronic appliances. Each such unit has one or more power cords plugged in to one or more of the outlets. PDUs also have power cords that can be directly hard wired to a power source or may use a traditional plug and receptacle connection. PDUs are used in many applications and settings such as, for example, in or on electronic equipment racks. One or more PDUs are commonly located in an equipment rack (or other cabinet), and may be installed together with other devices connected to the PDU such as environmental monitors, temperature and humidity sensors, fuse modules, or communications modules that may be external to or contained within the PDU housing. A PDU that is mountable in an equipment rack or cabinet may sometimes be referred to as a Cabinet PDU, or “CDU” for short.

A common use of PDUs is supplying operating power for electrical equipment in computing facilities, such as data centers or server farms. Such computing facilities may include electronic equipment racks that comprise rectangular or box-shaped housings sometimes referred to as a cabinet or a rack and associated components for mounting equipment, associated communications cables, and associated power distribution cables. Electronic equipment may be mounted in such racks so that the various electronic devices are aligned vertically one on top of the other in the rack. One or more PDUs may be used to provide power to the electronic equipment. Multiple racks may be oriented side-by-side, with each containing numerous electronic components and having substantial quantities of associated component wiring located both within and outside of the area occupied by the racks. Such racks commonly support equipment that is used in a computing network for an enterprise, referred to as an enterprise network.

As mentioned, many equipment racks may be located in a data center or server farm, each rack having one or more associated PDUs. One or more such data centers may serve as data communication hubs for an enterprise. Furthermore, many PDUs include network connections that provide for remote control and/or monitoring of the PDUs. Such PDUs may include power control relays that may be actuated by a remote user to interrupt power to one or more of the outputs of a PDU. Furthermore, such PDUs may include the ability to report information related to the PDU to a user or system located remotely from the PDU. For example, a PDU may report a total amount of power being provided by the PDU to a power management system, which may monitor such information and provide such information to one or more users of the power management system, such as network administrators. PDUs may monitor one or more of several different parameters related to the power provided through the PDU, such as current, voltage, and/or some other power-related parameter. As will be readily recognized, space within equipment racks is valuable with maximization of computing resources for any given volume being desirable.

### SUMMARY

Methods, systems, and devices for power parameter sensing using power sensing components integrated into a relay are described. A power distribution unit may be provided with switched outputs that may provide or interrupt power provided to the output through a plurality of relays. The plurality of relays may include an integrated power sensor configured to sense one or more power parameters associated with power delivered to a respective power output.

According to some embodiments, a power control relay apparatus is provided that comprises a housing having a power input, a control input, a power output, and a sense output; a switch coupled with the power input, control input, and power output that interrupts power provided from the power input to the power output responsive to the control input; and a power sensor coupled with one or more of the power input and power output and the sense output, and configured to output, through the sense output, a signal representative of the magnitude of power flowing through the power output. In some embodiments, a printed circuit board may be located in the housing, and wherein the switch and power sensor are mounted to the printed circuit board. Such a printed circuit board may comprise a plurality of through holes, the power input, control input, power output, and sense output provided to contacts that penetrate the through holes. The power sensor may comprise a current sensing transformer, a hall effect sensor, a MEMS-based power sensor, and/or a resistive voltage divider based power sensor.

According to another set of embodiments, a power distribution apparatus is provided that comprises a housing having a power input; a plurality of power outputs disposed in the housing, each connectable in power supply communication with the power input and at least one electronic appliance; and at least one power control relay coupled with one or more of the plurality of power outputs, the power control relay comprising a relay housing that comprises a switching element and a power sensor. The power distribution apparatus may further comprise a power-related information reporting system coupled with the at least one power control relay and configured to report power-related information derived from the power sensor to a remote system. In some embodiments, a display system is coupled with the power-related information reporting system, the display system comprising a digital visual display located on a face of the housing adjacent the plurality of power outputs, and configured to display at least a subset of the power-related information derived from the power sensor. The power input may comprise a polyphase power input, with different subsets of the plurality of power outputs being coupled with a different phase of power from the polyphase power input, and the display system may be configured to simultaneously display at least a subset of the power-related information derived from two or more of the different phases of power.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label.

FIG. 1 shows a block diagram of a power distribution unit in accordance with various embodiments;

FIG. 2 is an illustration of a face of a power distribution unit in accordance with various embodiments;

FIG. 3 is a circuit diagram of a power control relay and power sensor in accordance with various embodiments;

FIG. 4 shows a block diagram of a relay in accordance with various embodiments;

FIG. 5 shows a perspective view of a power control relay and power sensor in accordance with various embodiments; and

FIG. 6 shows a perspective view of a power control relay and power sensor enclosed within an associated housing in accordance with various embodiments.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, aspects and elements described with respect to certain embodiments may be combined in various other embodiments. It should also be appreciated that the following systems, devices, and components may individually or collectively be components of a larger system, wherein other procedures may take precedence over or otherwise modify their application.

The following patents and patent applications are incorporated herein by reference in their entirety: U.S. Pat. No. 7,043,543, entitled “Vertical-Mount Electrical Power Distribution Plugstrip,” issued on May 9, 2006; U.S. patent application Ser. No. 12/344,419, entitled “Power Distribution, Management, and Monitoring Systems,” and filed on Dec. 26, 2008; and U.S. patent application Ser. No. 12/717,879, entitled “Monitoring Power-Related Parameters in a Power Distribution Unit,” and filed on Mar. 4, 2010.

Systems and devices are described in which a power control relay, or other switching-type of component, may include an integrated current sensor. Such a configuration may reduce or eliminate the need for one or more separate current sensor components, thereby providing switching and sensing capabilities with reduced space requirements as compared to components having discrete switching and sensing components.

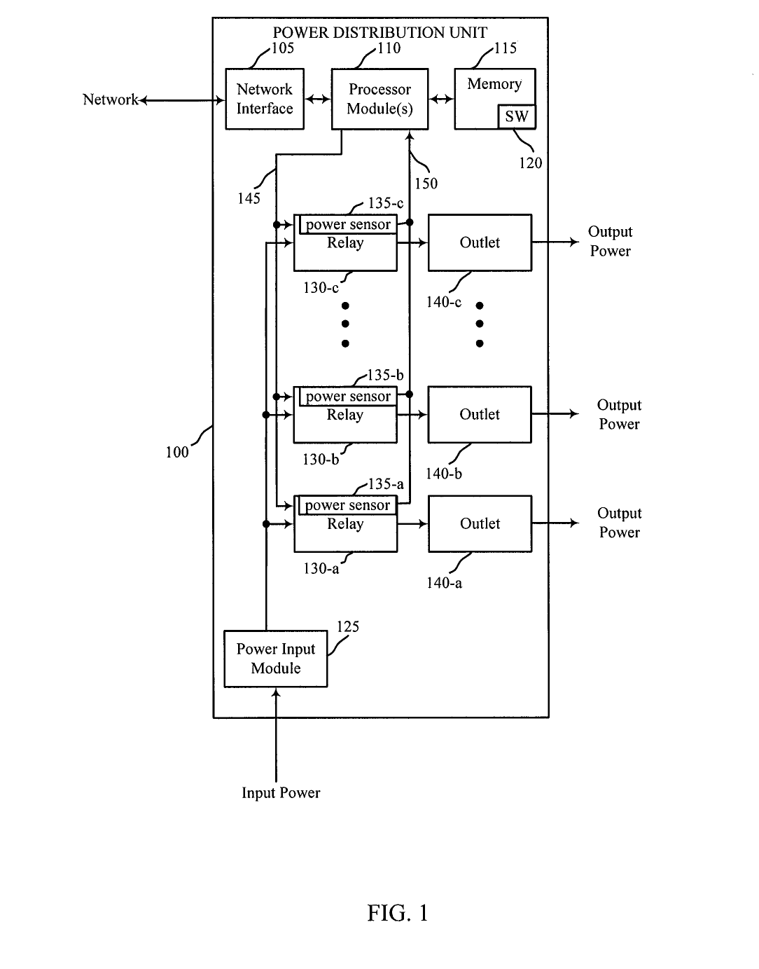

With reference now to FIG. 1, a block diagram of an exemplary system of an embodiment is now described. A PDU 100 supplies power to one or more associated electronic appliances. PDU 100 may have a housing that allows the PDU to be mounted in an equipment rack in either a vertical or horizontal orientation. Furthermore, a PDU, such as PDU 100, may receive, and supply, either AC or DC power, and embodiments that provide AC power may receive single or multiple phase power through one or more power inputs. The PDU 100 is useable in a computer network, and may communicate over the computer network with a network interface 105. The PDU 100 of this embodiment includes one or more processor module(s) 110, and a memory 115 that includes software 120 that, when executed by processor module(s) 110, cause the processor module(s) 110 to perform various operations related to functions of the PDU 100. A power input module 125 received input power and distributes the power to multiple relay modules 130. Relay modules 130 of various embodiments include a sensor 135 that may sense one or more parameters related to the power provided through the relay module 130, such as current, voltage, and/or some other power-related parameter. Outlets 140 are coupled with respective relay modules 130, and provide output power to electronic appliances that receive power from PDU 100. While various embodiments describe PDUs for use in equipment racks, it will be understood that various embodiments may be implemented in other applications and systems. For example, relay modules having integrated sensors may be used in electric vehicle charging stations, or other applications that may use a traditional relay to provide or interrupt power to a power output.

Communications with a network and remotely located equipment, such as a remotely located power manager application is conducted through network interface 105, which may include a communications module such as a network interface card (NIC). A network power manager may reside in a workstation or other device that is used in the management of a data center or other enterprise management, and issues network commands over a network communications connection to PDU 100, and one or more other PDUs, for example. The network interface 105 may include application firmware and hardware that allows the PDU 100 communicate with various remote systems or computers. In some embodiments, the PDU 100 includes a plurality of power outlets 140 arranged within an intelligent power module (IPM), in which case an IPM may include a processor that performs one or more functions of the PDU for the associated power outlets. Relay modules 130 control the application of power from the input power module 125 to a corresponding power outlet 140, and is in communication with the processor module(s) 110 through relay control lines 145.

Processor module(s) 110, under the direction of a network power manager, may control relay modules 130 to provide power and power cycling on-off for one or more of the corresponding power outlets 140. Processor module(s) 110 may receive sense signals from sensors 135 through one or more sense lines 150. Processor module(s) 110 may also be connected to other sensing components, such as input and/or output voltage sensing devices, input current sensing devices, environmental sensors (e.g., temperature and humidity devices), etc. The processor module(s) may use this information to determine the power supplied through an outlet, aggregate power supplied by the PDU 100, current usage of one or more outlets 140, voltage of the power input and/or one or more outlets, and the like, with such information provided through the network interface 105 to a remote network power manager. PDU 100, in some embodiments, may also include a display, for example a single-digit or multi-digit LED display, to provide a visual indication of voltage, current or another power metric locally at the PDU. In some embodiments, the input power may be polyphase input power, and the input power module 125 may be a polyphase module such as a three phase delta or wye configured input. In such polyphase embodiments, different groups of outlets 140 may be coupled with different power phases, and may include a display that displays power metrics for two or more of the phases simultaneously through different portions of the display or through physically separate displays that are associated with a particular power phase.

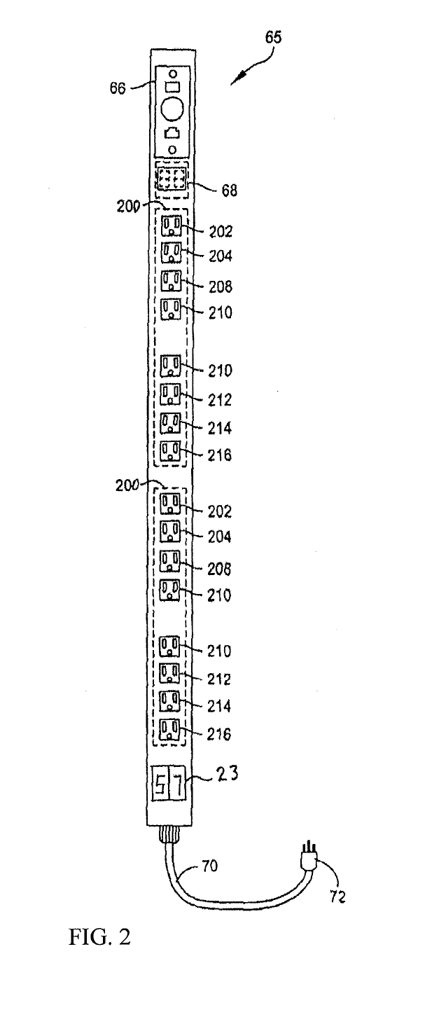

FIG. 2 is an illustration of a PDU 65 that includes Intelligent Power Modules 200, along with a communications module 66 that provides communications functions, an environmental monitor port 68, and an input power cord 70 with associated plug 72. The PDU 65 according to this embodiment includes a housing that is vertically mountable in an equipment rack, although it will be understood that other form factors may be used, such as a horizontally mountable housing. The Intelligent Power Modules 200 each include eight outlets 202-216 that supply power to assets that may be mounted into an equipment rack. Such equipment racks are well known, and often include several individual assets that are used in operation of a data center. As is well known, numerous equipment racks may be included in a data center, and in various embodiments each asset in each equipment rack may be monitored for power usage through one or more associated IPMs 200. The visual display 23 (shown displaying the numeral “57”) is disposed in the PDU 65 although in other embodiments the display might be external to the PDU 65, may display multiple items of information, and/or may include multiple separate displays.

In one embodiment, the power outlet module 200 includes eight outlets (202-216) each of NEMA 5-20R type, contained in a housing. It will be understood that this embodiment, and other embodiments described herein as having NEMA 5-20R type outlets, are exemplary only and that any of various other types of outlets alternatively can be used. For example, the “outlets” can be other NEMA types (e.g., NEMA 5-15R, NEMA 6-20R, NEMA 6-30R or NEMA 6-50R) or any of various IEC types (e.g., IEC C13 or IEC C19). It also will be understood that all “outlets” in a particular power outlet module 200, or other module-outlet described herein, need not be identical or oriented uniformly along the PDU. It also will be understood that the “outlets” are not limited to three-prong receptacles; alternatively, one or more of the “outlets” can be configured for two or more than three prongs in the mating male connector. It also will be understood that the “outlets” are not limited to having female prong receptacles. In any “outlet,” one or more of the “prong receptacles” can be male instead of female connection elements, as conditions or needs indicate. In general, as used herein, female and male “prong receptacles” are termed “power-connection elements”. Furthermore, the principles described herein also are applicable to devices that may be hard-wired into an outlet module. While outlet module 200 of this embodiment includes eight outlets, it will be understood that this is but one example and that an outlet module may include a different number of outlets.

The housing for an outlet module may be any suitable housing for such a device, as is known to one of skill in the art, and may be assembled with other modules in a PDU. Such a housing generally includes a front portion and a rear portion, the front portion is substantially planar, and the rear portion is substantially planar and parallel to the front portion. The housing also includes longitudinally extending side portions and transverse end portions. The front portion, rear portion, side portions, and end portions are generally orthogonal to each other in a generally rectangular or box-type configuration. The housing can be made of any suitable, typically rigid, material, including, for example, a rigid polymeric (“plastic”) material. In at least certain embodiments, the front and rear portions are made from an electrically insulative material, whereas in other embodiments conducting materials are used for safe ground bonding. The side portions and the end portions may be integrally formed, optionally along with the front portion or the rear portion. Furthermore, while the outlet module described in this embodiment includes a housing, other embodiments may include an outlet module that does not include a housing. For example, an outlet module may include a number of outlets coupled together with no exterior housing that may then be installed into another piece of equipment. Each outlet 202-216 is interconnected to the power source 32 through any of a number of well known connection schemes, such as spade, lug, plug connectors, screw connectors, or other suitable type of connector. Furthermore, if desired, one or more of these electrical connectors can be located inside the housing or outside the housing, in embodiments where the power outlet module includes a housing.

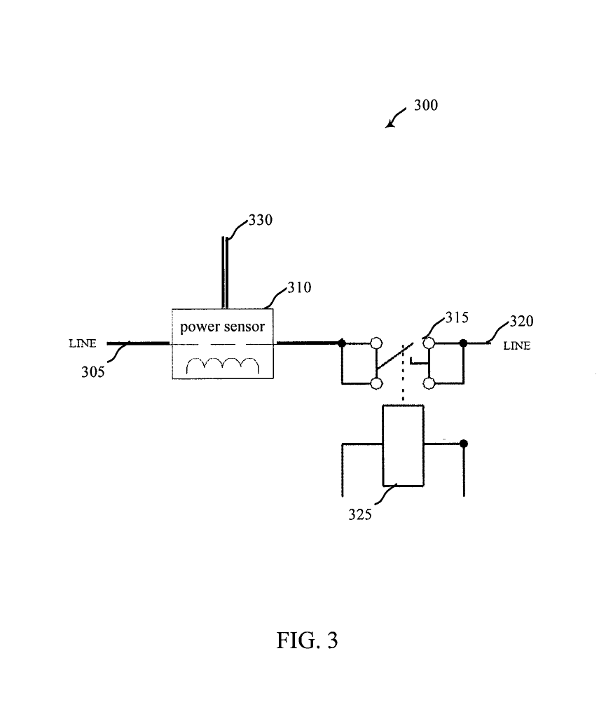

Referring now to FIG. 3, a schematic representation of a relay module 300 having an integrated current sensor is described. In this embodiment, line power 305 is provided through power sensor 310, such as a toroidal current sensor, to a relay switch 315. Line power 305 may be switched to and away from line output 320, to thereby energize and de-energize a power output coupled with the relay 315. Relay switch 315 is controlled through a relay control 325, as is well known. The toroidal current sensor 310 of the example of FIG. 3 provides sense outputs 330 that may be used to determine a magnitude of current flowing through the line input 305 to the switch element 315. While a toroidal current sensor 310 is illustrated, it will be readily understood that any of numerous different types of current sensors could be used in various applications, such as hall effect sensors or Micro Electro-Mechanical System (MEMS) based sensors, for example. Additionally, other types of power sensors could be used, such as voltage sensors.

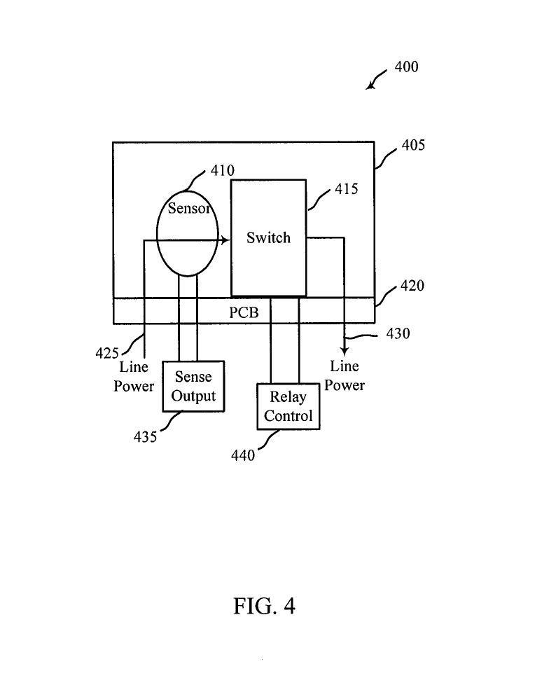

In some embodiments, the switching 315 and sensing 310 components may be integrated into a relay housing. For example, FIG. 4 illustrates a relay 400 comprising a relay housing 405 that encloses a power sensor 410 and a switch component 415. In this embodiment, sensor 410 and switch 415 elements may be mounted to a printed circuit board (PCB) 420 that is coupled with the housing 405. Line power in 425, line power out 430, sense output 435, and relay control 440 may be accomplished through electrical connections to the PCB 420. In some embodiments, several of such housings 405 may be incorporated into a PDU and may be mounted to, for example, a printed circuit board that is coupled with electrical outlets and one or more controllers.

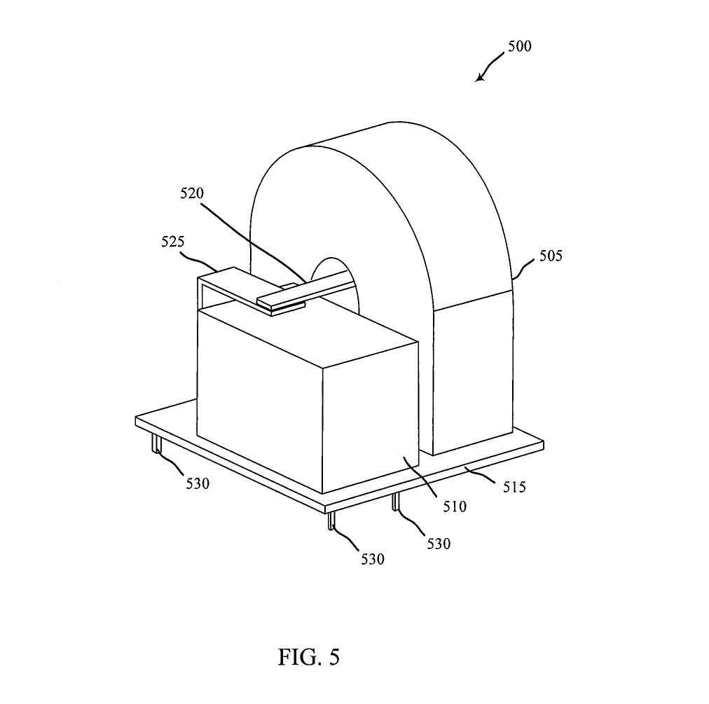

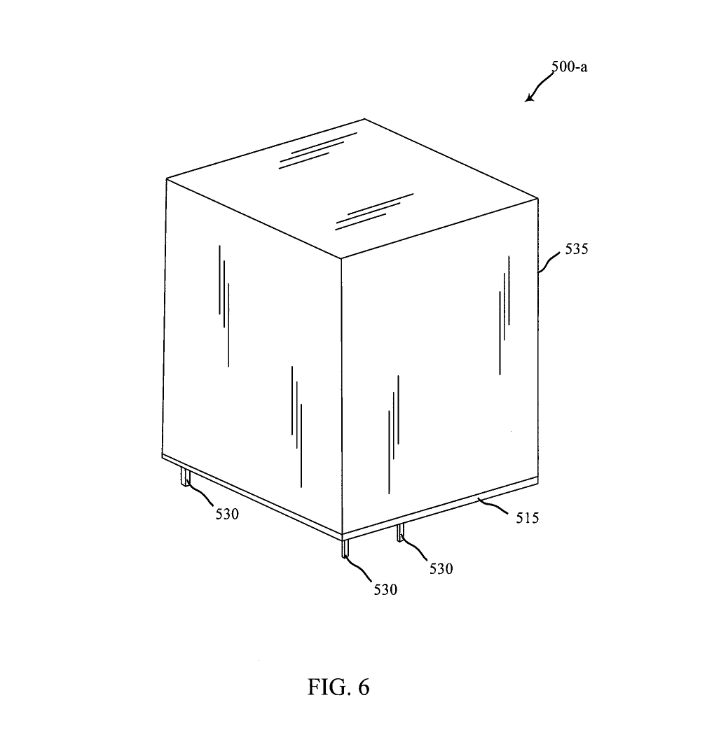

With reference now to FIGS. 5-6, a sensing relay 500 of some embodiments is described. In the illustration of FIG. 5, the relay 500 includes a current sensing transformer 505 and a relay 510 that are mounted to a printed circuit board 515. A line connection 520 runs through the current sensing transformer 505, and is connected to a spring element 525 of the relay 510. The spring element 525 may be a movable spring that is used in the relay to control the supply of current through the relay 510. The line connection 520 is connected to line power through a connection to the printed circuit board 515. In some embodiments, the line connection 520 and spring element 525 are welded together, although numerous other techniques and configurations for the supply of line power through a sensing element to a relay may be used and readily recognized by one of skill in the art. Pins 530 may be used to provide electrical connection between components of sensing relay 500 and external components. In some embodiments, the printed circuit board 515 includes six pins 530, two of which providing line power in and out of the sensing relay 500, two for providing sense output, and two for providing relay control. FIG. 6 illustrates a housing 535 that may be coupled with the sensing relay 500.

According to some embodiments, the sensing relay 500 has a maximum current capability of approximately 17 Amperes, of a printed circuit board area of approximately 32 mm by 27 mm. In some embodiments, when the relay 510 is energized, current will flow through line connection 520 and spring element 525, generating a field in the current sensing transformer 505. In one embodiment, the current sensing transformer 505 has a sensitivity ratio of 2500:1, and a the 17 A current flow will generate a 6.8 mA output from the current sensing transformer 505. The relay 510 may include components that are typical of such devices, including an actuator, a reverse spring, a yoke, a moving iron, a core, a coil, a frame, and a stationary spring that is associated with movable spring 525.

Embodiments described herein provide several benefits relative to separate relay and power sensing components. For example, embodiments provide that functions may be accomplished using fewer components. Fewer components may result is a simplified wiring harness or wiring interconnect system, such as commonly used in PDUs. Assembly time and cost may be reduced, and reliability may be increased. Furthermore, embodiments may be used to produce a product that has a smaller footprint than possible using discrete components.

It should be noted that the systems and devices discussed above are intended merely to be examples. It must be stressed that various embodiments may omit, substitute, or add various procedures or components as appropriate. For instance, it should be appreciated that, in alternative embodiments, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, structures, and techniques have been shown without unnecessary detail in order to avoid obscuring the embodiments.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A power control relay apparatus, comprising:
a housing having a power input, a control input, a power output, and a sense output;
a switch coupled with the power input, control input, and power output that interrupts power provided from the power input to the power output responsive to the control input; and
a power sensor coupled with one or more of the power input and power output and the sense output, and configured to output, through the sense output, a signal representative of the magnitude of power flowing through the power output.

2. The apparatus of claim 1, further comprising:
a printed circuit board located in the housing, and wherein the switch and power sensor are mounted to the printed circuit board.

3. The apparatus of claim 2, wherein the printed circuit board comprises a plurality of through holes, the power input, control input, power output, and sense output provided to contacts that penetrate the through holes.

4. The apparatus of claim 1, wherein the power sensor comprises a current sensing transformer.

5. The apparatus of claim 1, wherein the power sensor comprises a hall effect sensor.

6. The apparatus of claim 1, wherein the power sensor comprises a MEMS-based power sensor.

7. The apparatus of claim 1, wherein the power sensor comprises a resistive voltage divider based power sensor.

8. A power distribution apparatus, comprising:
a housing having a power input;
a plurality of power outputs disposed in the housing, each connectable in power supply communication with the power input and at least one electronic appliance; and
at least one power control relay coupled with one or more of the plurality of power outputs, the power control relay comprising a relay housing that comprises a switching element and a power sensor.

9. The apparatus of claim 8, further comprising:
a power-related information reporting system coupled with the at least one power control relay and configured to report power-related information derived from the power sensor to a remote system.

10. The apparatus of claim 9, further comprising:
a display system coupled with the power-related information reporting system comprising a digital visual display located on a face of the housing adjacent the plurality of power outputs, and configured to display at least a subset of the power-related information derived from the power sensor.

11. The apparatus of claim 10, wherein the power input comprises a polyphase power input, different subsets of the plurality of power outputs being coupled with a different phase of power from the polyphase power input, and
wherein the display system is configured to simultaneously display at least a subset of the power-related information derived from two or more of the different phases of power.

12. The apparatus of claim 8, wherein the power sensor comprises a current sensing transformer.

13. The apparatus of claim 8, wherein the power sensor comprises a hall effect sensor.

14. The apparatus of claim 8, wherein the power sensor comprises a MEMS-based power sensor.

15. The apparatus of claim 8, wherein the power sensor comprises a resistive voltage divider based power sensor.

16. The apparatus of claim 8, wherein the relay housing further comprises:
a printed circuit board located in the relay housing, and wherein the switching element and power sensor are mounted to the printed circuit board.

17. The apparatus of claim 16, wherein the printed circuit board comprises a plurality of through holes, the power input, control input, power output, and sense output provided to contacts that penetrate the through holes.

18. A power distribution apparatus, comprising:
a housing having a power input;
a plurality of power outputs disposed in the housing, each connectable in power supply communication with the power input and at least one electronic appliance; and
a plurality of power control relays, each of the power control relays coupled with a respective one of the plurality of power outputs, each of the power control relays comprising a relay housing that comprises a switching element and a power sensor.

19. The apparatus of claim 18, further comprising:
a power-related information reporting system coupled with the at least one power control relay and configured to report power-related information derived from the power sensor to a remote system.

20. The apparatus of claim 18, wherein the relay housings each comprise:
a printed circuit board located in the relay housing, and wherein the switching element and power sensor are mounted to the printed circuit board.
